(19) United States
(12) Patent Application Publication
(10) Pub. No.: US 2006/0133989 A1
(43) Pub. Date: Jun. 22, 2006

(54) Process and device for cooling inorganic pigments

(76) Inventors: Robert J. Sarracini, Eaton (AU); John Y. Wong, Australind (AU); Shane R. Garton, Bunbury (AU)

Correspondence Address: LYONDELL CHEMICAL COMPANY, 3801 WEST CHESTER PIKE, NEWTOWN SQUARE, PA, 19073, US

(21) Appl. No.: 11/290,012

(22) Filed: Nov. 30, 2005

Related U.S. Application Data
(60) Provisional application No. 60/632,246, filed on Nov. 30, 2004.

(51) Int. Cl. C09C 1/36; C01G 23/047

(52) U.S. Cl. 423/613; 106/437

(57) ABSTRACT

The present invention provides articles of manufacture and methods for making inorganic pigments. In one embodiment, the present invention provides a method for making titanium dioxide, said method comprising: (a) reacting titanium tetrachloride with oxygen in the presence of heat to produce titanium dioxide; and (b) cooling the titanium dioxide in a conduit having a helix, wherein said helix comprises at least one helical bend. Preferably the conduit comprises at least three helical bends, wherein the helix comprises at least three 360 degree spiral turns, and wherein the helix comprises an angle of from one to ten degrees. In a second embodiment, the present invention also provides a helical pipe for manufacturing pigment, comprising a conduit for receiving an inorganic pigment, wherein said conduit comprises a helix and wherein said conduit is capable of withstanding temperatures greater than about 650° C.

### RELATED APPLICATION

This application claims the benefit of Provisional Application 60/632,246 filed Nov. 30, 2004.

### BACKGROUND OF THE INVENTION

The present invention relates to methods and devices for making titanium dioxide and other inorganic pigments.

One well known method of making titanium dioxide is the chloride process. According to this method, titanium tetrachloride and oxygen, in gaseous form, are mixed in a reactor at high flow rates. The reactor is operated at a high temperature, which facilitates the formation of particulate titanium dioxide and gases. These products are subsequently cooled as they pass through a conduit that is typically a tubular heat exchanger which may, for example, be immersed in a flue pond to facilitate heat exchange.

In order to improve the efficiency of chloride processes, a scouring medium can be added to the heat exchanger to remove products that adhere to the inside surfaces of the conduit. A variety of scouring media are known in the art.

Typically, scouring media only partially remove deposits from the inside surfaces of the conduit. To the extent that deposits on the conduit surface are not removed, these deposits interfere with heat exchange. For example, as deposits adhere to the inner surface of the conduit, heat exchange in the conduit becomes less and less efficient, which adversely affects the ability of the titanium dioxide to cool in a satisfactory manner. This in turn leads to a possible decline in quality of the titanium dioxide particles.

In order to improve the quality of TiO₂ particles produced by the chloride process, and the efficiency of the processes themselves, tubular heat exchangers that are straight but comprise abrupt bends, or doglegs, may be included. Although such heat exchangers can be more effective heat exchangers than those lacking such abrupt bends, they can be somewhat disadvantageous due to rapid wear from the large angle of the bend. This wear can result in high maintenance costs. Tubular heat exchangers that are straight but comprise sweeping bends, e.g., wide angled bends, are also known in the art. These may present less wear than tubular heat exchangers with abrupt bends.

Parameters other than the shape of the pipe may also be modified to improve efficiency of heat exchange. For example, tubular heat exchangers for the cooling of titanium dioxide pigments, with internal fins, are known in the art. Internal fins are employed in an effort to enhance cooling by the tubular heat exchanger. Also known in the art are flues that have a plurality of internal longitudinal protuberances, depressions, or both. Furthermore, the interior surface of the flue can be corrugated and can have a plurality of protuberances that are fins, which, for example, can be hollow. Additionally, tubular heat exchangers for the cooling of titanium dioxide pigments, with internal spiraling vanes, are known in the art.

Unfortunately, tubular heat exchangers that merely have protuberances, depressions, spiraling vanes, or recesses disposed on their internal surfaces, have certain disadvantages. The features on the internal surfaces can serve to promote build-up of deposits at the location of these features, and can interfere with effective scouring of the internal surface of the heat exchanger. These disadvantages can reduce heat transfer efficiency. These features may also add significant costs to the construction of a heat exchanger.

As stated above, heat transfer efficiency in the tubular heat exchanger may be improved by having the scouring medium follow a spiral path by the use of, for example, four spiraling vanes and recesses on the inside surface of the tubular heat exchanger.

Unfortunately, although it is desirable to reduce the amount of scouring media used in a heat exchanger, excessive use of scouring media can adversely affect the quality of inorganic pigment particles.

Thus, a need remains to develop methods and articles of manufacture for improved cooling of inorganic pigments, for example, titanium dioxide, where build-up of deposits is avoided, interference with effective scouring of the internal surface of the heat exchanger is reduced, and the use of scouring media is reduced. The present invention provides a solution.

### SUMMARY OF THE INVENTION

The present invention provides devices and methods for making inorganic pigments and particles. The methods and devices include those suitable for improved cooling of gases and particulates during and after the formation of inorganic pigments and particles. The methods and devices are particularly suitable for forming titanium dioxide particles.

In one embodiment, the present invention provides a method for making titanium dioxide, said method comprising: (a) reacting titanium tetrachloride with oxygen in the presence of heat to produce titanium dioxide; and (b) cooling the titanium dioxide in a conduit having a helix, wherein said helix comprises at least one helical bend.

In another embodiment, the present invention provides a method for making titanium dioxide, said method comprising: (a) reacting titanium tetrachloride with oxygen in the presence of heat to produce titanium dioxide; and (b) cooling the titanium dioxide in a conduit having a helix, wherein said helix comprises at least three helical bends, wherein said at least three helical bends form a helix with at least three 360 degree spiral turns, and wherein the helix has a helix angle of from one to ten degrees.

In another embodiment, the present invention provides a helical pipe for manufacturing a pigment, comprising a conduit for receiving an inorganic pigment, wherein said conduit comprises a helix and wherein said conduit is capable of withstanding temperatures equal to or greater than about 650° C.

### BRIEF DESCRIPTION OF THE FIGURES

The preferred embodiments of the invention have been chosen for purposes of illustration and description but are not intended to restrict the scope of the invention in any way. The preferred embodiments of certain aspects of the invention are shown in the accompanying figures, wherein:

FIG. 1 illustrates a left-handed helical conduit of Example 1.

FIG. 2 illustrates design criteria for the helical conduit of Example 1.

FIG. 3 is a schematic diagram of the helix arrangement of the conduit of Example 1.

FIG. 4 is a schematic diagram of the transition helix of FIG. 3.

FIG. 5 is a schematic diagram of the conduit of Example 1, showing the radius of curvature.

FIG. 6 depicts the helical pipe with a five degree helix angle and five and one half turns of Example 5.

FIG. 7 is a representation of scrub salt usage using the helical pipe of Example 5.

FIG. 8 is a representation of flow rates using the helical pipe of Example 5.

FIG. 9 is a representation of flue pipe pressure drop in kPa, as a function of tons per hour, for the helical pipe of Example 5 (new 5 degree helical pipe) and the helical pipe of Example 1 (before new 5 degree helical pipe).

FIG. 10 is a representation of a viscosity comparison using the helical pipe of Example 5 (with new 5 degree helical pipe) and the helical pipe of Example 1 (before new 5 degree helical pipe).

FIG. 11 is a schematic representation of a flue pond used in the examples, indicating straights and bends.

FIG. 12 is a process block diagram of titanium dioxide raw pigment production.

### DETAILED DESCRIPTION OF THE PREFERRED EMBODIMENTS

The present invention will now be described in connection with preferred embodiments. These embodiments are presented to aid in an understanding of the present invention and are not intended to, and should not be construed, to limit the invention in any way. All alternatives, modifications and equivalents that may become obvious to those of ordinary skill upon reading the disclosure are included within the sprit and scope of the present invention. For a better understanding of the present invention together with other and further advantages and embodiments, reference is made to the following description taken in conjunction with the examples, the scope of the invention which is set forth in the appended claims.

This disclosure is not a primer on processes for making inorganic pigments; basic concepts known to those skilled in the art have not been set forth in detail.

Definitions

Unless otherwise specified, or apparent from context, the phrases and terms used herein include the following meanings.

Abrupt Bend

The phrase “abrupt bend,” as used herein, includes what are referred to in the art as “dog legs.” An “abrupt bend” or “dog leg” is a bend in a conduit or flue, that represents a deviation in a straight or linear conduit or flue. An “abrupt bend” is typically a turn of angle from about 90 to about 170 degrees. An “abrupt bend” is distinguished from a “sweeping bend” in that in an abrupt bend there is a sudden transition or change of angle, which alters sharply the direction of flow as opposed to a gradual, smooth, and uniform transition of flow for a sweeping bend.

Conduit

The term “conduit” as used herein includes a pipe or flue, or any other structure that can enclose gaseous, vaporous and particulate reactants and reactant products and provide a pathway for them to travel away from the zone in which they are formed. The term “conduit” includes, but is not limited to, tubular heat exchangers. The conduit can be made from any material known in the art, or that a person of ordinary skill in the art, with this disclosure in hand, would appreciate would be useful in the practice of this invention.

Cooling

The term “cooling” as used herein includes a reduction in temperature of matter. Using the methods and articles of manufacture described in this disclosure in accordance with the invention, matter traveling through the conduit of the invention will experience reduction in temperature.

Constant Helix Angle

The phrase “constant helix angle,” as used herein, includes a helix angle that does not vary from one helix, helical segment, or helical bend, when compared to other helices, helical segments, or helical bends according to the present invention. The phrase “helical segment” is meant to include a segment of a conduit that comprises a helix. Typically, but not necessarily, a “helical segment” is a segment of pipe that comprises a full helical turn (i.e., 360 turn of a helix), wherein the segment of pipe can be, for example, welded, or otherwise attached, to one or more other pipe segments. The one or more other pipe segments comprise one or more helical segments, one or more bends, and/or one or more straight runs.

Depression

The term “depression,” as used herein, includes a deviation on the inside surface of a tubular heat exchanger that describes an involution of the inside surface of the tubular heat exchanger.

Fin

The term “fin,” as used herein, includes a protuberance on the inside surface of a tubular heat exchanger. The “fin” may be comprised of the same or different composition as the tubular heat exchanger. The “fin” may be triangular, or may take any shape that aids in heat exchange, reduction in build-up, and/or efficiency of scouring.

Helical Bend

The phrase “helical bend,” as used herein, includes a portion of a helix. The phrase “portion of a helix” is any length of helix that ramifies about an imaginary central axis in accordance with the formula of a helix. Many formulas describing helices are known in the art.

Helix

The term “helix,” as used herein, includes a circular helix, which can typically be described by a well known vector function, for example the vector function r(t)=acosti+asintj+c+k, wherein c does not equal zero. Typically, but not always, a helix will lie within an imaginary circular cylinder described by x²+y²=a². Where c>0, the helix is a right-handed circular helix. There c<0, the helix is a left-handed circular helix. As used herein, unless otherwise specified or indicated by the context, however, “helix” is meant to be construed in its broadest sense. The helices of the present invention can be described by any formulas known in the art and are thus not limited to regular helices nor regular helices that can be contained within regular cylinders. In one non-limiting example, “helix” can include a helix that is not uniformly straight, e.g., the helix need not lie in a straight cylinder, but the cylinder within which the helix can be thought to be contained can, itself, comprise one or more curves. In another non-limiting example, helices of the invention do not necessarily need to be uniform and regular, e.g., deviation from the central axis of the helix need not be uniform.

Helix Angle

The phase “helix angle,” as used herein, includes the angle formed by the direction of travel of the helical conduit, which determines its helical periodicity and magnitude around an imaginary straight central axis or imaginary cylinder. The “helix angle” is measured in three dimensional coordinates with the x-axis pointing in the direction of the central axis and tangent to any point on a line traced out by the locus of travel of the helical conduit.

The helix angle values used in this disclosure are a corollary analogy. The values are expressed in this disclosure in a manner that may be the inverse of the usual, or common, definition employed by many persons who are skilled in the art of mechanical engineering. For example, to many persons skilled in the art of mechanical engineering, the helix angle may be defined by the nominal length of a helix against the circumference of the imaginary cylinder that the center of the helical pipe is coiled onto. Thus, with respect to usage herein, 3 degrees as used herein may be to a person skilled in the art of mechanical engineering more typically referred to as 87 degrees, 5 degrees as referred to herein may be more typically referred to as 85 degrees, and so on. The expression of helix angle values in this disclosure are, for purposes of convenience only, 5 degrees rather than 85 degrees, and 3 degrees rather than 87 degrees, and so on.

Inorganic Pigment

The term “inorganic pigment,” as used herein, includes any inorganic pigment known in the art, or that comes to be known and/or can be cooled using a conduit or one of the methods of the present invention. Preferably, the inorganic pigment is a titanium-based pigment. More preferably, the inorganic pigment is an oxide of titanium. Most preferably, the inorganic pigment is titanium dioxide.

Rifle

The term “rifle,” as used herein, includes a depression of the internal surface of a tubular heat exchanger, wherein the depression occurs over at least one spiral turn or full turn of a helix.

Scouring Medium

The phrase “scouring medium,” as used herein, includes any medium known in the art, or that comes to be known in the art, that is useful for scouring in a tubular heat exchanger. “Scouring media” include, but are not limited to, sand, mixtures of inorganic pigment such as, for example, titanium dioxide and/or sintered titanium dioxide in any acceptable form to achieve scouring, compressed pigments such as compressed titanium dioxide, salts and salt mixtures, rock salts, alumina, and fused alumina. Salts can include, for example, potassium chloride, sodium chloride, and cesium chloride.

Spiral Turn

The phrase “spiral turn,” as used herein, includes a portion of a helix that describes a full turn of the helix.

Sweeping Bend

The phrase “sweeping bend,” as used herein, includes bends that allow for a heat exchanger to be contained in a flue pond. Typically, the length of a heat exchanger can be increased by introducing one or more “sweeping bends” into the heat exchanger, allowing it, for example, to follow the contours of a flue pond. “Sweeping bends” preferably have wide angles, which are defined by their radii of curvature.

Vane

The term “vane,” as used herein, includes a protuberance on the inside surface of a tubular heat exchanger. The “vane” may be of the same or different composition as the tubular heat exchanger. The “vane” may be triangular, or may take any shape that aids in heat exchange, reduction in build-up, and/or efficiency of scouring.

Variable Helix Angle

The phase “variable helix angle,” as used herein, includes a helix angle that can vary along a helix or helical segment.

### PREFERRED EMBODIMENTS

In one embodiment, the present invention provides a method for making titanium dioxide, said method comprising: (a) reacting titanium tetrachloride with oxygen in the presence of heat to produce titanium dioxide; and (b) cooling the titanium dioxide in a conduit having a helix, wherein said helix comprises at least one helical bend.

According to this embodiment, the helix preferably has a helix angle from one degree to twenty-five degrees. More preferably, the helix angle is from two to ten degrees. Most preferably, the helix angle is from three to five degrees. In a particularly preferred embodiment, the helix angle is five degrees. The helix angle can be constant along the helix. Alternatively, the helix angle can vary along the helix. Preferably, the helix angle is constant along the helix. Considerations in selecting a suitable helix angle include the efficacy of the resulting helical conduit in achieving improved heat transfer as compared to a conduit that is not helical, the efficacy of scouring, the build-up of deposits on the inner surface of the conduit, and the wear of the internal surfaces of the conduit. Efficiency of a helical conduit can be improved by increasing the helix angle to, for example, five degrees, allowing shortening of the helical conduit and permitting more helix per unit length of the conduit as compared to helix angles of less than five degrees.

A suitable helical conduit can be designed by selecting a conduit comprising at least one helical segment of constant or variable helix angle, and employing the conduit comprising at least one helical segment as a heat exchanger in a flue pond. Temperature surveys of the flue pond in the vicinity of the conduit at various points along the conduit can be taken to measure the heat balance around the flue pond and determine heat transfer dynamics of the conduit. These temperature surveys can be used to estimate heat fluxes of various sections of the conduit and the temperatures of the flow stream inside the conduit.

Preferably, at least 10% of the conduit is a helix. More preferably, at least 50% of the conduit is a helix. Most preferably, 75% to 100% of the conduit is a helix. In embodiments where the conduit is less than 100% helix, the conduit preferably comprises one or more transition zones between helical segments and straight or non-helical segments. A transition zone comprises a zone of conduit wherein the conduit changes its articulation. For example, a transition zone can comprise a zone wherein a helical portion of the conduit converts to a straight portion, and vice versa.

For conduits that are not all helix, preferably the conduit comprises at least one helical bend. More preferably, the conduit comprises at least two helical bends. Most preferably, the conduit comprises at least three helical bends.

Preferably, the conduit comprises a helix with at least one 360 degree spiral turn. More preferably, the conduit comprises a helix with at least two 360 degree spiral turns. Most preferably, the conduit comprises a helix with at least three 360 degree spiral turns. In general, the longer the conduit, the more 360 degree spiral turns the conduit preferably comprises.

The conduit can also comprise at least one abrupt bend. Abrupt bends include what is known in the art as “dog legs.” However, abrupt bends should be kept to a minimum, because abrupt bends can lead to significant maintenance cost from high wear. Alternatively, in addition to the helix angle, the conduit can comprise at least one sweeping bend. A sweeping bend is typically a wide angle bend in a heat exchanger. Sweeping bends can be desirable where a greater length of heat exchanger is desired in a single flue pond. For example, a rectangular flue pond can be made to comprise more heat exchanger length where sweeping bends are used so that the heat exchanger can turn within the flue pond to, for example, follow the perimeter of the flue pond. One or more segments of such a heat exchanger can comprise a helix.

On the inside of the conduit, one or more fins, vanes, rifles, depressions, spirals, or combinations thereof can be used. The one or more fins, vanes, rifles, depressions, spirals, or combinations thereof can be used in any segment of the conduit, including in a helix segment.

The methods of the present invention are preferably carried out using a scouring medium. Any scouring medium, or combination of scouring media, now known in the art or that comes to be known can be used in conjunction with the present invention. The scouring medium can comprise, for example, sand, one or more metal halides, CsCI, compacted TiO₂ particles, calcined TiO₂ particles, or combinations thereof. Where the scouring medium includes one or more metal halides, the metal halide is preferably NaCI, KCI, or a combination thereof. However, any suitable scouring medium known in the art, or that comes to be known and would be useful in scouring in connection with the present invention, can be used.

In another embodiment, the present invention comprises a method for making titanium dioxide, said method comprising: (a) reacting titanium tetrachloride with oxygen in the presence of heat to produce titanium dioxide; and (b) cooling the titanium dioxide in a conduit having a helix, wherein said helix comprises at least three helical bends, wherein said helical bends form a helix with at least three 360 degree spiral turns, and wherein the helix has a helix angle of from one to ten degrees.

In another embodiment, the present invention comprises a helical pipe for manufacturing an inorganic pigment, comprising a conduit for receiving an inorganic pigment, wherein said conduit comprises a helix and wherein said conduit is capable of withstanding temperatures greater than 650° C. The helical pipe can comprise one or more right-handed helices, one or more left-handed helices, and/or combinations thereof.

In another embodiment, the helical pipe comprises a lumen that contains titanium dioxide.

The inorganic pigment made with the methods and conduits of the current invention can be any inorganic pigment. Preferably, the inorganic pigment comprises titanium. More preferably, the inorganic pigment comprises one or more titanium oxides. Most preferably, the inorganic pigment is titanium dioxide.

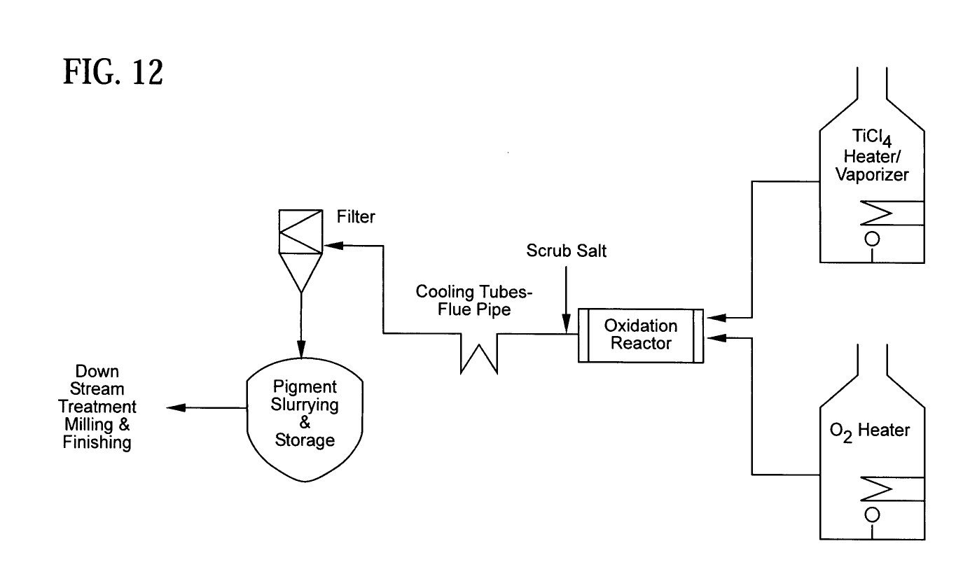

Titanium dioxide can be made by any method known in the art, such as, for example, the sulfate process or the chloride process. Most preferably, the titanium dioxide is made using the chloride process. In the chloride process, titanium tetrachloride is reacted with oxygen in a high temperature reactor, in an oxidation reaction, followed by rapid cooling in a length of pipe, sometimes referred to as a flue pipe. The pipe, or flue pipe, comprises a conduit by which cooling can occur as the titanium dioxide travels through the conduit. The conduit is typically immersed in a flue pond. Following the oxidation reaction, the reaction is rapidly quenched as the product exits the reactor to avoid undesirable particle growth. Methods for making raw pigment from an oxidation reactor or oxidizer are well known in the art. A block process diagram for making titanium dioxide via a chloride process is illustrated in FIG. 12.

Typically, the product enters an externally cooled conduit, or pipe or flue pipe, to rapidly cool the exiting gas stream and titanium dioxide particles. The conduit is typically a tubular heat exchanger. To ensure good heat transfer in the conduit, scouring media are typically added to the hot gaseous stream to remove excess buildup of pigment on the internal wall of the conduit. Common scouring agents include any abrasive substance, including, for example, sand, rock salt, sodium chloride, potassium chloride, cesium chloride, pelleted or sintered titanium dioxide, compacted particles of titanium dioxide, and the like. It is known in the art that a bimodal particle size distribution of scouring agent is particularly effective, and the use of salt has benefits reduction in pressure drop over the bag filter used to separate the titania particles from the chlorine. Any scouring medium known in the art, or that comes to be known in the art, can be used in conjunction with this invention.

The conduit, which can be a pipe, flue pipe, or any other kind of conduit known in the art, serves as a heat exchanger. The scouring media removes deposits from the inner surface of the heat exchanger so as to maintain satisfactory heat transfer. The heat exchanger, or conduit, is typically made of a plurality of individual heat exchanger sections that are connected, such as, for example, by bolting the individual sections together. Many methods of making pipe are known in the art. For example, for the helical pipe employed in the examples, straight pipe is cut into desired lengths, usually with each length long enough for making one helix. Each length of pipe is then individually heated up inductively and twisted to the specification. These lengths are welded back afterwards together to form the helical pipe.

The present invention uses helical pipe sections in part or along the entire length of the conduit, or heat exchanger, to create one or more spiral paths that can reduce the use of scouring media or more efficiently effectuate scouring.

Among the advantages of the present invention include the ability to minimize the use of scouring media, such as salt, in the manufacture of the pigment. Salt, in particular, is known to be deleterious to final pigment quality, particularly to the qualities of opacity and gloss. Thus, it is desirable to minimize the use of salt. For example, using a twenty-seven meter helical section with a helix angle of 3 degrees in an existing heat exchanger reduced salt usage by 40% to 50% and reduced bend mill feed slurry viscosity by 50%. Increased final milling rates on neutral tone grade or blue tone grade raw pigment were observed by up to 28%. After thirty days of use, the conduit was inspected and displayed no noticeable wear with respect to its internal surface.

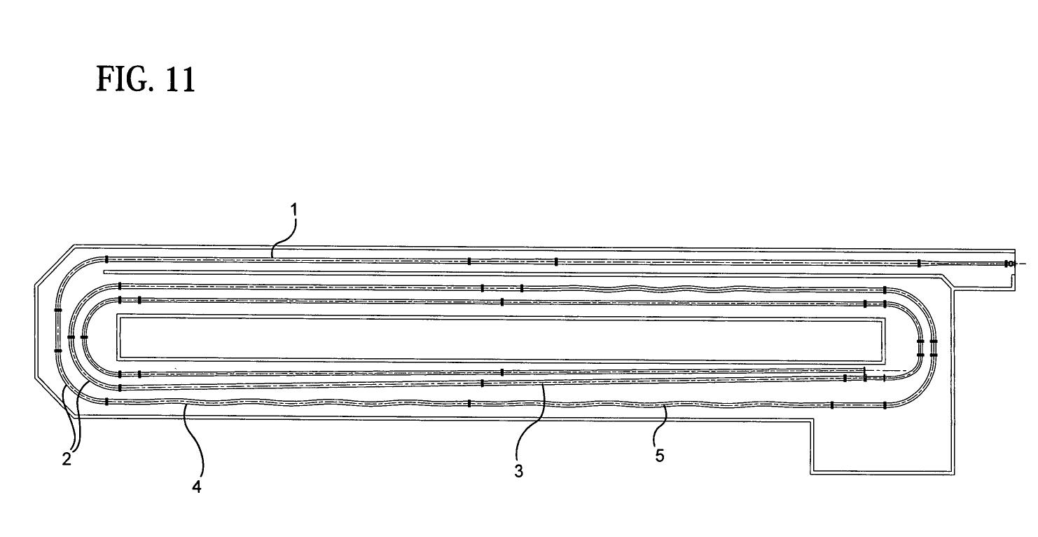

Maximizing production rate at a pigment manufacturing plant, such as a TiO₂ plant, benefits from debottlenecking the plant process by allowing higher production rates to be achieved by transferring more heat from the process stream into the flue pond cooling water through the flue pipe. Tube pipe currently known in the art can be used, but maximizing production rate can lead to increased scrub salt use that would likely lead to excessive wear on the heat exchanger and add significant costs for both maintenance and for increased scrub salt. Installing abrupt bends (dog legs) in the flue pipe that deflect process flows abruptly such that the inner wall of turbulent zones is relatively clean can be used, thus increasing heat transfer effectiveness, although this can lead to rapid wear from the large bend angles and so lead to higher maintenance costs. FIG. 11 is a schematic representation of a flue pond used in the examples described herein, indicating straights and bends. The first straight (1), sweeping bends (2), a second straight (3), the location of a 3 degree helical pipe for a first trial and a 5 degree helical pipe for a second trail (4), and the location of a 3 degree helical pipe for a second trial (5) are shown.

However, the use of helical segments with spiral bends of, for example, 3 degrees, 5 degrees, or combinations of such segments, would not wear as rapidly as larger angled abrupt bends, or dog legs. Thus, even if a particular helical segment removes only as much heat as an abrupt bend, a helical segment is a superior alternative.

The invention offers a variety of advantages, including, but not limited to, as noted above, a reduced need for scouring media. A helical path allows for more effective scouring. Reduction of scouring media such as salt can enhance downstream processing by, for example, allowing higher feed rates through wet milling by lowering the viscosity of the mill feed, and increasing post-treatment filtered solids due to creation of smaller flocculations. Smaller particle sizes are desirable for bluer undertone pigments, which is particularly desirable for titanium dioxide pigments in certain markets. Smaller particle size also allows for higher production rates than can be achieved with existing heat exchangers.

Minimizing salt use enhances downstream processing, including allowing high feed rates through wet milling by lowering the viscosity of the mill feed and increasing post-treatment filtered solids due to creation of smaller flocculations. Minimizing salt usage can also lead to bluer undertone pigment, a desirable quality for titanium dioxide pigments in the master batch and plastics markets. Smaller particle size also enables higher production rates than can be achieved with existing heat exchangers.

The helical pipe is a technical accomplishment of many benefits. The main effect is the increase in heat removal efficiency, which can bring about a significant reduction of scrub salt usage. The subsequent decrease of salt level in the pigment slurry can lower the viscosity, and it may also have positive effects on the interparticle forces/properties. These contribute to many benefits in downstream processes.

Having now generally described the invention, the same may be more readily understood through the following reference to the following examples, which are provided by way of illustration and are not intended to limit the present invention unless specified.

### EXAMPLES

### Example 1

### Trial With a Helical Conduit Having a Three Degree Helix Angle

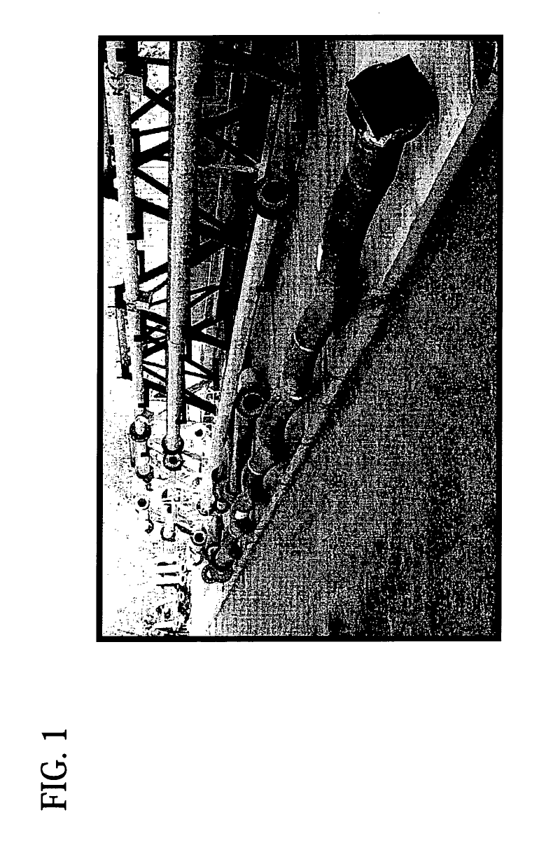

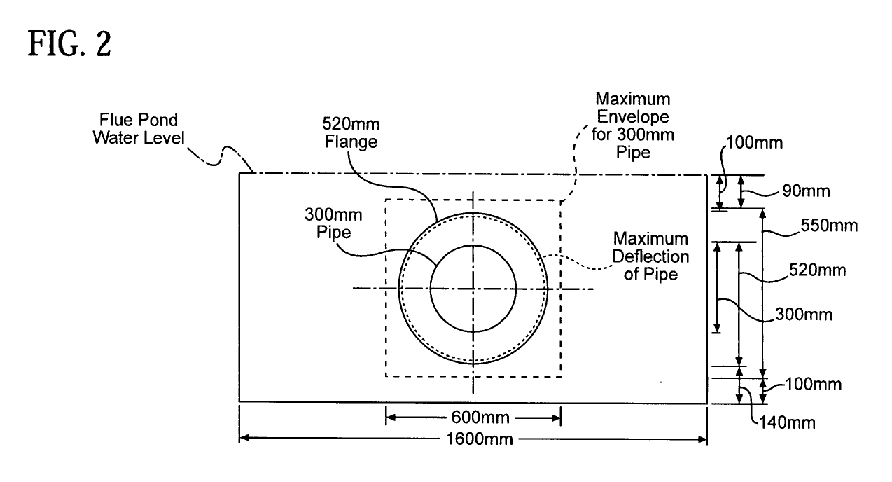

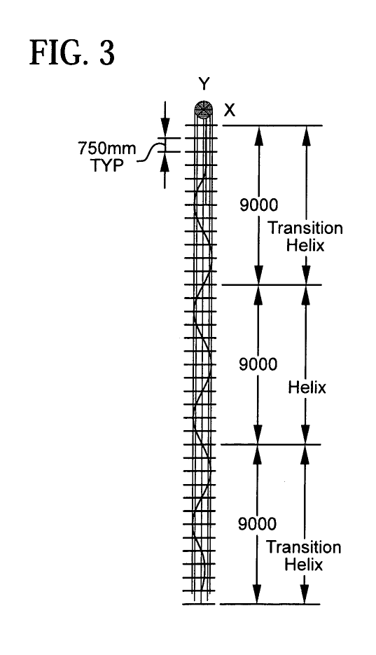

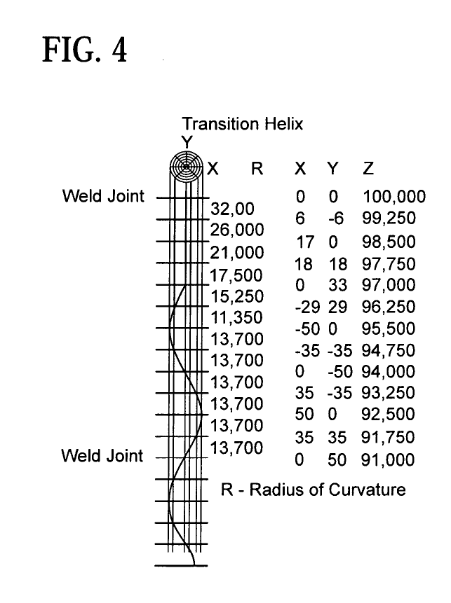

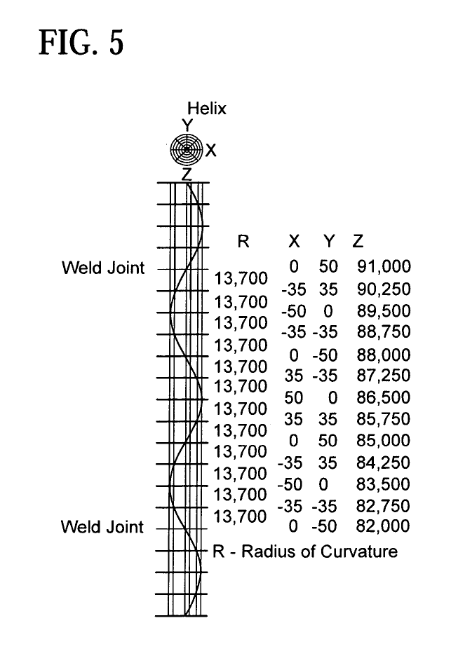

A helical conduit made from a 27.5 meter-long flue pipe with a 300 mm diameter, having a constant helix angle of 3 degrees, with three helical bends that were each complete 360 degree spiral turns was installed in a heat exchanger in a flue pond. The heat exchanger was connected directly to the outlet of an oxidation reactor. The heat exchanger was made up of several loops of pipes immersed in cooled water and the helical conduit was installed at the first length of the second loop. The helical conduit removed an additional 83 kJ/s of heat as compared with a straight conduit of the same nominal length in the same position, rendering the helical conduit about 21.6% more efficient than the straight conduit. “Straight” or “nominal” length refers to the length of a helix or helical pipe. If uncoiled, the pipe would be longer by about 0.25 m per helix. The furthest deviation of the helix was 100 mm from the center of the helical pipe, and the maximum crest-to-crest deviation was 200 mm. The 100 mm maximal deviation was selected so that no portion of the pipe was elevated above or below a flange, and that the pipe would not contact the flue pond wall or another pipe. The helical conduit was constructed of Inconel 600 alloy pipe, schedule 40 or 90 to 11 mm wall thickness. This material is particularly suited to high temperature and hot chlorine duty. Other higher grades of the same alloy such as Inconel 601 and 625 are also suitable. Hastelloys can be used as well. However, they are all more costly than Inconel 600 and only marginally superior. A representation of the helical pipe used is shown in FIG. 1. Design criteria for the helical conduit are illustrated in FIG. 2. A schematic of the helical pipe is shown in FIG. 3, showing the conduit comprised of three helical segments of 9000 mm, with lengths of straight conduit on each end of the helical conduit. FIG. 4 is a schematic of the transition helix. FIG. 5 is a schematic of the helical conduit showing weld joints. Three 9,000 mm sections were made, such that each comprises a single complete spiral with a 100 mm deviation from the center line. This formation allowed each end to finish in the same plane and allowed the sections to be butt welded together. Straight lengths were used to make up for shortfalls in overall pipe length. The helical pipe was installed into the first length of the second straight of a flue pipe. The flue pipe was immersed in a flue pond.

Temperature surveys of the flue pond were carried out. Temperature measurements helped establish the heat balance around the flue pond and establish the heat transfer dynamics of the flue pipe. The results were also used to estimate the heat fluxes of various sections of the flue pipe and the temperatures of the flow stream inside the flue pipe. Heat flux analysis suggested that the helical pipe would be most advantageous in the last length of the first straight of the flue pipe. Helical pipe in this location would remove the equivalent of 83 degrees C. of heat/temperature for the reaction product stream, five times more than at the second straight.

The predominant amount of heat associated with making titanium dioxide, about 60% of the total, was generated by the TiCI₄ to TiO₂ reaction. The majority of the heat—about 73% to 76%—was removed by the first straight up to the second bend. Regarding the titanium dioxide grade made, i.e., neutral tone grade versus blue tone grade, the remainder of the flue pipe after the second bend removed more heat by 200 to 300 kJ/s. This could be related to either lower velocity of the flow stream or longer residence time of the neutral tone run. This may have accounted for the lower scrub salt usage of 0.3 to 0.5% for neutral tone production in comparison to blue tone. The scrub salt only affected the first straight of the flue pipe. This was evident in three trails in which the bag filter inlet temperature was reduced by 15 degrees C. from 195 degrees C. to 180 degrees C. Both the second bend and third bend temperatures dropped by the same margin. The theoretical calculated temperature of the reaction products was estimated to be about 2,100 degrees C. The actual temperature was probably several hundred degrees lower due to the highly endothermic dissociation of a percentage of the CI₂. Depending on the flue pond water final temperature, the evaporative heat loss varied from 3000 to 5000 kJ/s or 30% to 45% of the total heat rejected from the flue pipe into the flue pond water. The amount of water lost through evaporation to the atmosphere was significant at 5 to 7.5 m³/h. The heat flux of the flue pipe varied from 138 kJ/m² to 5.6 kJ/m². The high number was from the 225 mm NB (nominal bore or nominal internal diameter) flue pipe on the first straight and the latter near to the end of the flue pipe.

The inventors concluded that heat transfer efficiency of the helical conduit might be further improved by increasing the helix angle to 5 degrees. Increase in helix angle would shorten the helix and allow more spiral, or helix, per unit length of the conduit.

### Example 2

### Scrub Salt Usage

Average data for scrub salt usage during runs with and without a helical pipe are displayed in Table II.

TABLE II
Average Scrub Salt Usage

| Run | Rate (tph) | NaCl (%) | Grade | Helical or Straight |
|---|---|---|---|---|
| 1 | 11.4 | 2.29 | Neutral tone | Straight pipe |
| 2 | 10.47 | 3.48 | Blue tone | Helical pipe |
| 3 | 11.30 | 2.32 | Neutral tone | Helical pipe |
| 4 | 11.00 | 2.13 | Neutral tone | Helical pipe |
| 5 | 10.40 | 2.59 | Blue tone | Helical pipe |
| 6 | 11.33 | 1.91 | Neutral tone | Helical Pipe |
| 7 | 9.24 | 1.29 | Neutral tone | Helical Pipe |
| 8 | 9.39 | 1.93 | Blue tone | Helical Pipe |
| 9 | 10.24 | 1.73 | Neutral tone | Helical Pipe |
| 10 | 10.27 | 2.31 | Blue tone | Helical Pipe |
| 11 | 9.88 | 2.57 | Blue tone | Straight Pipe |
| 12 | 11.27 | 2.22 | Neutral tone | Straight pipe |

Run number describes runs for this specific study described in this table.

Srub salt usage was about 0.3 to 0.5% lower for the neutral tone run. Variation of NaCI scrub salt and rate on a daily basis was measured for nine months with the helical conduit in place, and averaged about 15% less than when using a heat exchanger having no helical conduit when normalized to reactor rate.

The 0.3 to 0.5% scrub salt difference between blue tone and neutral tone corresponded to the 200 to 300 kJ/s heat removal after the third bend. The helical pipe removed additional 83 kJ/s of heat in a blue tone run, relative to a straight pipe. This would be at least equivalent to =83/200×0.3=0.125% or about 0.1% scrub salt reduction.

### Example 3

### Scouring, Wear, and Flow Resistance Using Helical Pipe

The helical pipe was removed between Runs 3 and 4 in Table II, and a video was taken on the interior wall of the helical pipe. The video traversed the whole length. It showed that the scrub salt scoured mainly the bottom quarter to fifth of the wall forming a faintly distinct path. The path of the scouring did follow the helical profile and became slightly more prominent at the most outward points/bends. This indicated the helical pipe should have more area for heat transfer and so should be more efficient to remove heat from the flow stream.

Thickness measurements were made on several selected locations (perceived to have high wear) when the helical pipe was first taken out. No decrease in thickness or wear occurred. The same measurement was taken when the helical pipe was removed from the flue pond following 10 months of continuous service. The wear was negligible.

From the flue pipe differential pressure (that is, the pressure drop across the length of the flue pipe, or DP trend), it was not possible to ascertain if the helical pipe contributed to DP increase. If it did, it must have been insignificant, because no drastic increase in flue pipe DP was observed with the 3 degree helical pipe in place.

### Example 4

### Helical Pipe Efficiency

Helical pipe efficiency was determined for a blue tone run conducted using the conduit of Example 1. The helical pipe removed an additional 83.2 kJ/s of heat relative to the straight flue pipe it replaced. This was equivalent to an additional heat of 121.6% of the straight pipe or 21.6% more efficient in heat removal. Details of the efficiency calculation are listed below.

With Helical Pipe (27 m of helical pipe to 32 m
of straight pipe, or 46% to 54%)

| | |
|---|---|
| Average second bend temperature: | 669.6° C. |
| Average third bend temperature: | 499.7° C. |
| Average temperature difference: | 169.9° C. |
| Average mass flow: | 35,600 kg/h = 9.89 kg/s |
| Average reaction product heat capacity: | 0.62 kJ/kg/° C. |
| Heat removed: | 1041.7 kJ/s |
| Assume mass flow = 8.89 kg/s (normalized | |
| to be the same as with straight pipe) | |
| Heat removed: | 936.3 kJ/s |

Without Helical Pipe - With 27.5 m Straight Pipe

| | |
|---|---|
| Average second bend temperature: | 655.3° C. |
| Average third bend temperature: | 500.5° C. |
| Average temperature difference: | 154.8° C. |
| Average mass flow: | 32,000 kg/h = 8.89 kg/s |
| Heat removed: | 853.1 kJ/s |
| Difference in heat removal: | 83.2 kJ/s |

From these data, it was estimated that the helical pipe efficiency = (384.5 + 83.2)/384.5 = 121.6% of the straight pipe, representing 21.6% greater efficiency in heat removal.

### Example 5

### Helical Pipe Having a 5 Degree Helix Angle

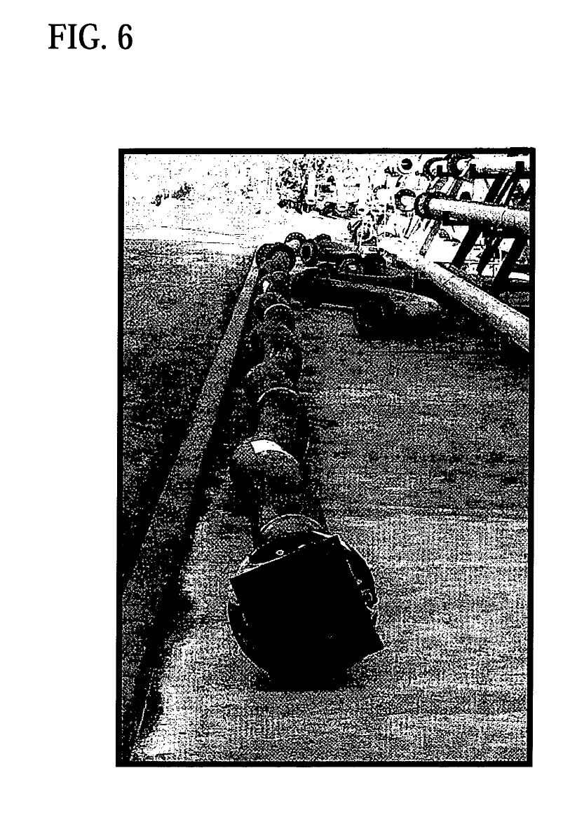

A 27.5 meter helical pipe with a 5 degree helix angle, having 5 ½ turns, was made. The helix was left-handed. A depiction of the left-handed helical pipe with a 5 degree helix angle and 5 ½ turns is shown in FIG. 6. This helical pipe was installed in the first length of the second straight flue pipe location. The helical pipe has a twist such that the off-center distance increased by only 50 mm more than the helical pipe of Example 1, to ensure that the crests would remain submerged in the flue pond. The helical pipe with 5 degree helix angle was placed in tandem with the helical pipe having the 3 degree helix angle. The helical pipe with the 5 degree helix angle was installed in the first length of the second straight flue pipe, and the helical pipe with the 3 degree helix angle was moved to the second length position and joined to the helical pipe with the 5 degree helix angle. The 5 degree helical pipe generated more turbulence of the flow stream, which enhanced heat removal. By immediately attaching the 3 degree helical pipe, the more vigorous residual turbulence from the 5 degree helical pipe would continue forward for a longer duration.

### Example 6

### Results of Runs with Tandem Helical Pipes

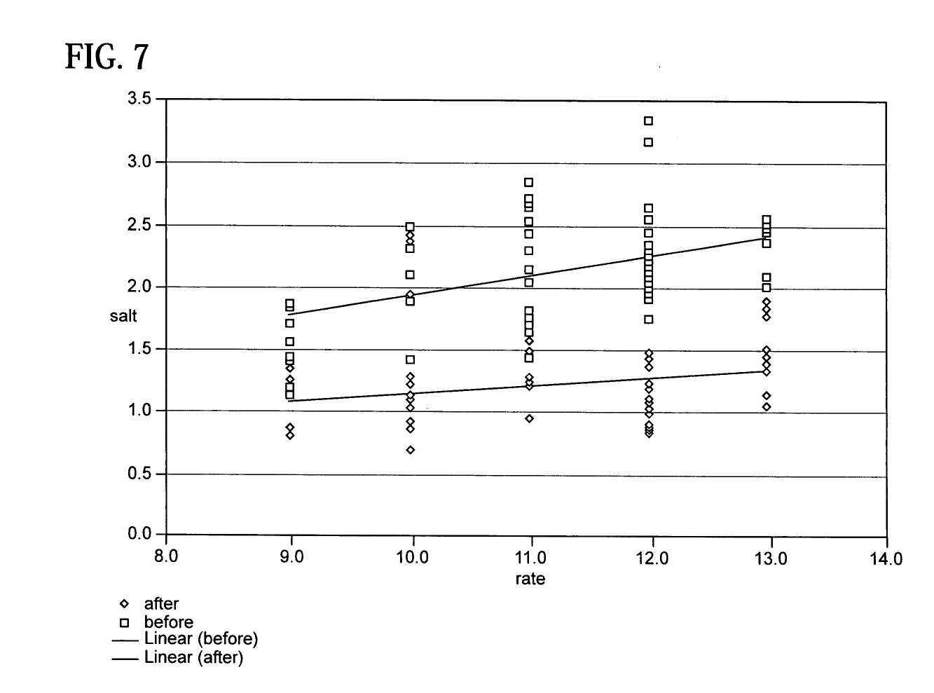

Runs with the tandem helices reduced scrub salt usage. The average salt content in a slurry containing a pigment collected from the filter and mixed with water before the addition of the helical pipe having the 5 degree helix angle was 2.09% and with the helical pipe having the 5 degree helix angle was 1.23%. This is equivalent to a reduction of 41.1% in scrub salt usage. Conservatively, if a 30% reduction in scrub salt is assumed, the scrub salt saving would be significant per year. Scrub salt usage using the helical pipe of Example 5 is shown in FIG. 7 (illustrating scrub salt usage on the Y axis as a function of production rate on the X axis). Almost one percent less scrub salt was used with the helical pipe of 5 degree helix angle in tandem with the helical pipe of 3 degree helix angle, as compared with the helical pipe of 3 degree helix angle, as compared with the helical pipe of 3 degree angle alone.

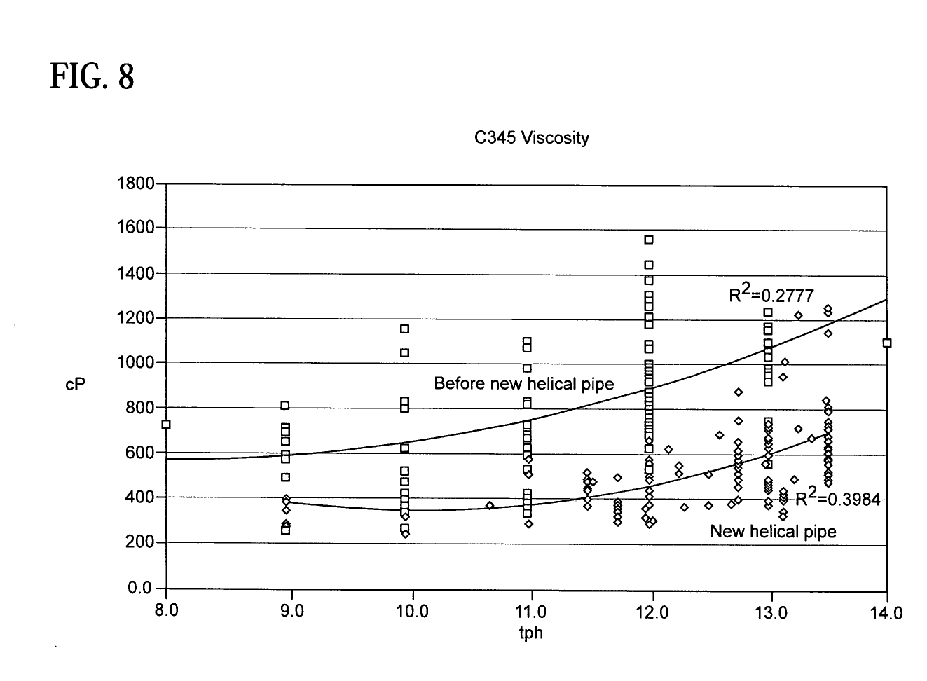

Slurry viscosity also decreased across a range of reactor rates using the two helical pipes in tandem. As illustrated in FIG. 8, at flow rates from 9 to over 13 tone per hour, the two helical pipes in tandem (“new 5 degree helical pipe”) consistently produced slurry of about two hundred centipoises (cP) lower than without the two helical pipes (“before new 5 degree helical pipe”). The average reduction in slurry viscosity was from 913 to 553 cP. This was not due to a change in slurry density. Instead, the reduction was due to the reduction in scrub salt, since the slurry solids content actually increased slightly by 26 g/L for the tandem helical pipe runs. Slurry viscosity is affected very much by the pigment slurry solids content as well as scrub salt level. If the slurry is higher in solids or salt content or both, the slurry viscosity is higher. In this case, the solids content of the slurry had increased slightly, but the reduction in salt level still resulted in a significant fall in slurry viscosity.

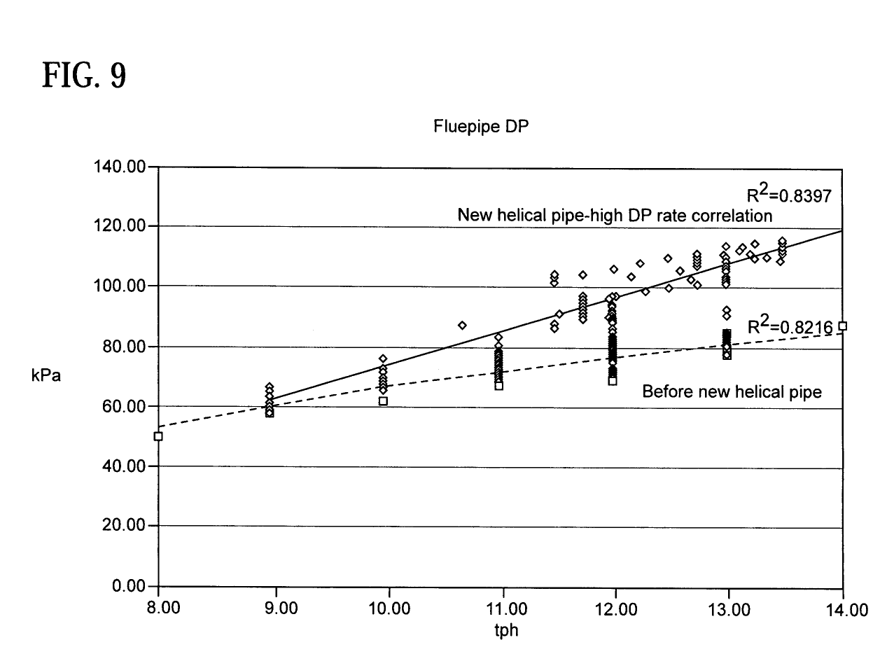

The tandem helical pipe affected flue pipe pressure drop in a consistent manner, linear with plant rates. However, the tandem helical pipe arrangement generated higher pressure drop-approximately 25 kPa higher. Flue pipe pressure drop, shown as a plot of kPa vs. tons per hours, is illustrated in FIG. 9. The linearity observed cannot be explained in theory. If the pressure drop is due to rate increase alone, the relationship should be proportional to the square of the rate (velocity), which is not linear. It is probable that increase in plant pressure at higher rates and additional scrub salt mitigated the square effect of rates. The tandem arrangement created a higher and wider range of pressure drop than before.

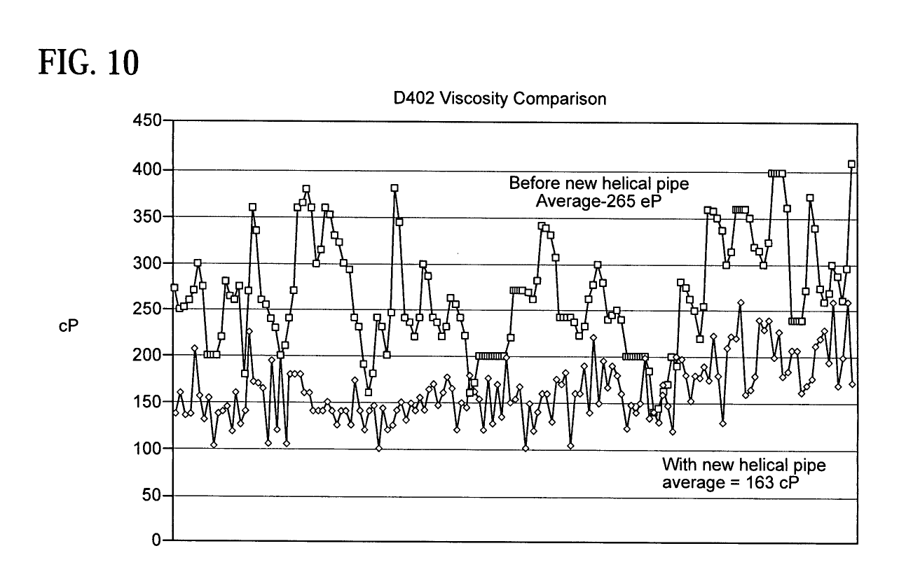

Some reduction in sand mill feed slurry viscosity was observed. The average was 265 cP, before the helical pipe having a 5 degree helix angle was added, and 163 cP after the helical pipe having 5 degree helix angle was added. FIG. 10 shows a plot of the change in viscosity, and is a comparison over about a month's time. Reduction in sand mill feed slurry viscosity would permit more efficient milling. Reduction in viscosity could also allow slight increases in milling rate.

Reduced scrub salt and less heat transfer at the first straight of the flue pipe, since addition of the helical pipe with 5 degree angle, can lead to changes in pigment particle size. Immediate quenching of hot pigment emerging from the reactor has been moderated to some extent. Hotter gaseous and product stream moving down the first straight of the flue pipe would promote particle growth. With the increase in pressure drop of the flue pipe comes increased pressure at the reactor, a situation that tends to favor larger pigment particle size formation. This can be overcome by changing the flue pipe to the original configuration on the first straight, with, for example, a longer 225 mm pipe.

The new helical arrangement wherein the 5 degree and 3 degree pipes were placed in tandem led to advantages in finishing, including indications of improved washing, reduction in steam and natural gas usages, and increase in processing (plant capacity). One benefit was an increase in processing rate (blue tones run; a superdurable chloride rutile pigment, at 93% TiO₂ content, and with 325 mesh fineness of 0.01% maximum retention) through a spray drier. The new 5 degree helical pipe arrangement allowed an increase in average hourly rate on micronizers of 0.64 to 0.73 tph. Denser pigment slurry feed, due to improved washing and dewatering as the result of reduction in salt content, was at least partly responsible for improvement in throughput at the spray driers.

Non-destructive testing (NDT) was carried out on the new 5 degree helical pipe after 3 weeks of operation. There was no indication of wear to the new 5 degree helical pipe. Theoretically, a possibility of increase wear exists for the first and second sweeping bends. This is because they are likely to encounter higher velocity and higher flow stream temperatures. These can lead to higher rate of erosion and corrosion. However, the increase in wear may not be significant, as it will be mitigated by reduction in salt usage.

The heat removal efficiency of the helical pipe of Example 1 (helix angle of 3 degrees) relative to a straight pipe is 21.6%. The considerable reduction in scrub salt indicated the new 5 degree helical pipe heat efficiency is most probably more than 100%. Recent trial data confirmed that the 5 degree helical pipe removed 513 kW of heat under similar trial conditions for the 3 degree helical pipe. This equates to a heat removal efficiency of 204% of a straight pipe, an increase of more than 5 times when compared with the 3 degree helical pipe. Evidently, there is a large increase in heat removal efficiency from 3 to 5 degree helix angle. Thus, it is preferred that helical pipes should have at least 4-5 degree helixes. If installed in the third or fourth straight of the flue pipe, a larger helix angle to deflect the flow is desirable, as wear is not anticipated to be a problem at these locations. However, there is a limit as the helix angle increases the off center distance (crest) of the helical pipe. In practicality, the helix angle will be limited by the depth of the flue pond containing the conduit; the helix angle should preferably not be so high as to result in a crest in the pipe rising above the surface of the flue pond.

The performance of the new 5 degree helical pipe opens up a new scope in the flue pipe configuration. As mentioned earlier, the third and fourth straight can be converted to helical pipes to further increase the heat transfer efficiency of the flue pond. This change would make the current last loop (fifth and sixth straight) of the flue pipe redundant. In fact, a second straight having a conduit with at least a 5 degree helical angle would be desirable.

Converting the second or third or fourth straight into helical pipe to increase their heat transfer efficiency is likely to cause the problem of maintaining acceptable pigment particle size. The reduction in scrub salt or scrubbing renders the first straight less efficient in heat transfer especially its function of quenching the reaction products. There is a possibility that the flue pipe pressure drop may become excessive due to the larger volume of the hotter gases. As such, installing the helical pipe into the first straight may be desirable under certain circumstances.

For neutral tone grade runs using the 5 degree helical pipe in tandem with the 3 degree helical pipe, the higher differential pressure and hotter first straight may have greater impact on the pigment particle size for the blue tone run. It may be slightly more difficult to produce smaller pigment particle size because the new 5 degree helical pipe in the location tested decreases the quenching effect of the first straight.

While the invention has been described in connection with specific embodiments thereof, it will be understood that it is capable of further modifications and this application is intended to cover any variations, uses, or adaptations of the invention following, in general, the principles of the invention and including such departure from the present disclosure as come within known or customary practice within the art to which the invention pertains and as may be applied to the essential features hereinbefore set forth and as follows in the scope of the appended claims.

What is claimed is:

1. A method for making titanium dioxide, said method comprising:
(a) reacting titanium tetrachloride with oxygen in the presence of heat to produce titanium dioxide; and
(b) cooling the titanium dioxide in a conduit comprising at least one helix, wherein said at least one helix comprises at least one helical bend.

2. The method according to claim 1, wherein at least one helix has a helix angle from one degree to twenty-five degrees.

3. The method according to claim 2, wherein the helix angle is from two to ten degrees.

4. The method according to claim 3, wherein the helix angle is from three to five degrees.

5. The method according to claim 2, wherein the helix has a constant helix angle.

6. The method according of claim 2, wherein the helix has a variable helix angle.

7. The method according to claim 1, wherein at least 10% of the conduit is helical.

8. The method according to claim 1, wherein at least 90% of the conduit is helical.

9. The method according to claim 1, wherein the conduit has at least two helical bends.

10. The method according to claim 9, wherein the conduit has at least three helical bends.

11. The method according to claim 10, wherein the conduit has at least three 360 degree spiral turns.

12. The method according to claim 1, wherein the conduit further comprises at least one abrupt bend.

13. The method according to claim 1, wherein the conduit further comprises one or more fins, vanes, rifles, depressions, spirals, or combinations thereof, and said one or more fins, vanes, rifles, depressions, spirals, or combinations thereof is located on the inside of said conduit.

14. The method of claim 1, further comprising using a scouring medium in the conduit.

15. The method of claim 14, wherein the scouring medium comprises sand, a metal halide, CsCI, compacted TiO₂ particles, calcined TiO₂ particles, or combinations thereof.

16. The method of claim 15, wherein the scouring medium is a metal halide and said metal halide is NaCI, KCI, or a combination thereof.

17. A method for making titanium dioxide, said method comprising:
(a) reacting titanium tetrachloride with oxygen in the presence of heat to product titanium dioxide; and
(b) cooling the titanium dioxide in a conduit having a helix, wherein said helix comprises at least three helical bends, wherein each of said at least three helical bends comprises a 360 degree spiral turn, and wherein the helix has an angle of from one to ten degrees.

18. A helical pipe for manufacturing pigment, said helical pipe comprising a conduit for receiving an inorganic pigment, wherein said conduit comprises a helix and wherein said conduit is capable of withstanding temperatures greater than 650° C.

19. The helical pipe according to claim 18, wherein the helical pipe comprises a lumen, and wherein said lumen contains titanium dioxide.

20. The conduit of claim 18, further comprising at least one non-helical region.
